(19) United States
(12) Patent Application Publication
(10) Pub. No.: US 2008/0101359 A1
(43) Pub. Date: May 1, 2008

(54) MULTICAST COMMUNICATION RESOURCE MANAGEMENT APPARATUS AND METHODS

(76) Inventors: Charles Michael Storry, Kemptville (CA); Hal Andrew Thorne, Raleigh, NC (US); Robert W. MacIntosh, Carp (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(21) Appl. No.: 11/554,955

(22) Filed: Oct. 31, 2006

(51) Int. Cl. H04L 12/56

(52) U.S. Cl. 370/390; 370/401

(57) ABSTRACT

Multicast communication resource management apparatus and methods are disclosed. Multicast communication modules receive respective multicast communication traffic streams and provide transmit streams for transmission toward multicast destinations, and have a limited aggregate capacity to support multicast communications with the destinations. The aggregate capacity includes respective amounts of capacity reserved for each of the destinations and a remaining unreserved amount of capacity. The reserved amounts of capacity are usable for communication with the respective destinations. The unreserved amount of capacity is made available as a pool for allocation to a destination for which the respective reserved amount of capacity is insufficient. The destinations may then fairly contend for usage of additional capacity from the unreserved pool. Data structures for tracking reserved and unreserved capacity are also disclosed.

### FIELD OF THE INVENTION

This invention relates generally to communications and, in particular, to managing resources for multicast communications.

### BACKGROUND

As part of the evolution of services such as Internet Protocol Television (IPTV) services that use multicast communications, there may be requirements to support an increasing number of multicast streams throughout a communication system. This may be due, for example, to higher numbers of channels being made available as part of an IPTV service and consumption of more streams on average per Set-Top Box (STB). Increased consumption may become particularly prevalent with the addition of multi-stream features such as a grid of simultaneously streamed images, referred to as IPTV mosaic.

When IPTV mosaic applications are employed, multiple streams are consumed by a single STB, and accordingly a higher number of multicast streams are required per subscriber, such as a household, than would have traditionally been required. Multiple STBs per household, to provide video signals to multiple TV sets for instance, can further increase the concurrent multicast stream demand. Concurrent stream requirements could easily increase by a factor of 10.

Multi-stream features such as mosaic applications can therefore lead to significant increases in multicast resource requirements in upstream multicast routers, such as access nodes. It may not be possible for existing access equipment to be able to simultaneously support control plane processing for, and/or transmission of, such a large number of potentially unique streams to all subscriber households concurrently. Existing access nodes may not have sufficient multicast resources to simultaneously support increased stream requirements for every port, for example.

In the case of IP multicast, sufficient IP multicast roots might not always be available. One currently available multicast implementation restricts the number of concurrent streams per port to be the total number of multicast roots divided by the total number of ports. However, this restricts multi-stream capabilities for all ports and therefore for all subscribers, even though statistically not all of the ports would be consuming the multicast root resources at the same time.

Thus, there remains a need for improved techniques for managing limited multicast communication resources.

### SUMMARY OF THE INVENTION

Some embodiments of the present invention provide for partitioning of multicasting resources so as to reserve a portion of the resources to guarantee a basic level of service to all multicast destinations while allowing the remainder of resources to be allocated from a pool on a first-come, first-served basis.

According to one aspect of the invention, an apparatus includes a plurality of multicast communication modules and a multicast manager. The multicast communication modules are operable to receive respective multicast communication traffic streams and to provide transmit streams for transmission toward destinations of the received multicast streams, and have a limited aggregate capacity to support multicast communications with the plurality of destinations. The aggregate capacity includes respective amounts of capacity reserved for each of the destinations and a remaining unreserved amount of capacity. The multicast manager is operatively coupled to the multicast communication modules and is operable to make the unreserved amount of capacity available for allocation to a destination for which the respective reserved amount of capacity is insufficient.

The multicast manager may be further operable to reserve the respective amounts of capacity for each of the destinations.

The multicast manager may make the unreserved capacity available by controlling allocation of an additional amount of capacity from the unreserved amount of capacity to a destination for which the respective reserved amount of capacity is insufficient.

Each multicast communication module may include a multicast stream interface operable to receive a respective multicast stream, and a replicator operatively coupled to the multicast stream interface and operable to replicate the received multicast stream to thereby provide a respective transmit stream for transmission toward each destination of the received multicast stream.

The apparatus may also include a plurality of destination interfaces operatively coupled to the multicast communication modules, each destination interface being operable to enable transmission of transmit streams to one of the destinations.

In some embodiments, the apparatus includes a configuration interface operatively coupled to the multicast manager and operable to enable configuration of at least one of: the aggregate capacity, the respective reserved amounts of capacity, and the unreserved amount of capacity.

The multicast manager may be further operable to receive from any of the destinations a request for allocation of an additional amount of capacity, and to control allocation of an additional amount of capacity from the unreserved amount of capacity responsive to a received request by determining whether a requested additional amount of capacity is available from the unreserved amount of capacity, and allocating the requested additional amount of capacity from the unreserved amount of capacity where the requested additional amount of capacity is available from the unreserved amount of capacity.

A reduced additional amount of capacity may be allocated from the unreserved amount of capacity by the multicast manager where the requested additional amount of capacity is not available from the unreserved amount of capacity.

If a plurality of requests are received, the multicast manager may control allocation of additional amounts of capacity by determining whether a total of additional amounts of capacity requested in the plurality of requests is available from the unreserved amount of capacity, and selecting, in accordance with a contention mechanism, one or more of the plurality of received requests for which requested additional amounts of capacity are to be allocated from the unreserved amount of capacity where the total of additional amounts of capacity requested in the plurality of requests is not available from the unreserved amount of capacity.

The multicast manager may also be operable to, where a reduced amount of capacity is sufficient for a destination, release at least a portion of an additional amount of capacity that has been allocated to the destination. Released capacity is available for re-allocation to a destination.

The multicast communication traffic streams may be video streams associated with an IPTV service.

An electronic circuit card for use in communication equipment may incorporate such an apparatus, and be installed in at least one slot of communication equipment that includes a plurality of slots for receiving electronic circuit cards.

A method of using a limited aggregate capacity to support multicast communications with a plurality of multicast destinations is also provided. The aggregate capacity includes respective amounts of capacity reserved for each of the destinations and a remaining unreserved amount of capacity. The method includes enabling the reserved amounts of capacity to be used for communications with the respective destinations, and making the unreserved amount of capacity available for allocation to a destination for which the respective reserved amount of capacity is insufficient.

The method may also include reserving the respective amounts of capacity for each of the destinations.

The operation of making the unreserved amount of capacity available may involve controlling allocation of an additional amount of capacity from the unreserved amount of capacity to a destination for which the respective reserved amount of capacity is insufficient.

In some embodiments, the method also includes receiving from a user a configuration input for configuring at least one of: the aggregate capacity, the respective reserved amounts of capacity, and the unreserved amount of capacity.

The method may also include receiving from any of the destinations a request for allocation of an additional amount of capacity. In this case, controlling may involve determining whether a requested additional amount of capacity is available from the unreserved amount of capacity, and allocating the requested additional amount of capacity from the unreserved amount of capacity where the requested additional amount of capacity is available from the unreserved amount of capacity.

Controlling may also involve allocating a reduced additional amount of capacity from the unreserved amount of capacity where the requested additional amount of capacity is not available from the unreserved amount of capacity.

If a plurality of requests are received, controlling may involve determining whether a total of additional amounts of capacity requested in the plurality of requests is available from the unreserved amount of capacity, and selecting, in accordance with a contention mechanism, one or more of the plurality of requests for which requested additional amounts of capacity are to be allocated from the unreserved amount of capacity where the total of additional amounts of capacity requested in the plurality of requests is not available from the unreserved amount of capacity.

In some embodiment, the method also includes determining whether a reduced amount of capacity is sufficient for a destination to which an additional amount of capacity has been allocated from the unreserved amount of capacity, and releasing at least a portion of the additional amount of capacity where a reduced amount of capacity is sufficient for the destination, released capacity being available for re-allocation to a destination.

As noted above, the multicast communication traffic streams may be video streams associated with an IPTV service.

Such a method may be embodied, for example, in instructions stored on a machine-readable medium.

A machine-readable medium storing a data structure is also provided. The data structure includes reserved resource data fields indicative of multicast communication resources that have been respectively reserved, from limited resources for supporting multicast communications with a plurality of multicast destinations, for each of the destinations, and unreserved resource data fields indicative of remaining unreserved resources of the limited resources and availability of the unreserved resources. The reserved resource data fields and the unreserved resource data fields enable determinations to be made as to whether resources reserved for a destination are insufficient, and whether additional resources are available from the unreserved resources for allocation to the destination where the resources reserved for the destination are insufficient.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of a communication system.

FIG. 2 is a block diagram of a multicast resource management apparatus.

FIG. 3 is a flow diagram of a multicast resource management method.

FIG. 4 is a block diagram of a data structure.

### DETAILED DESCRIPTION OF PREFERRED EMBODIMENTS

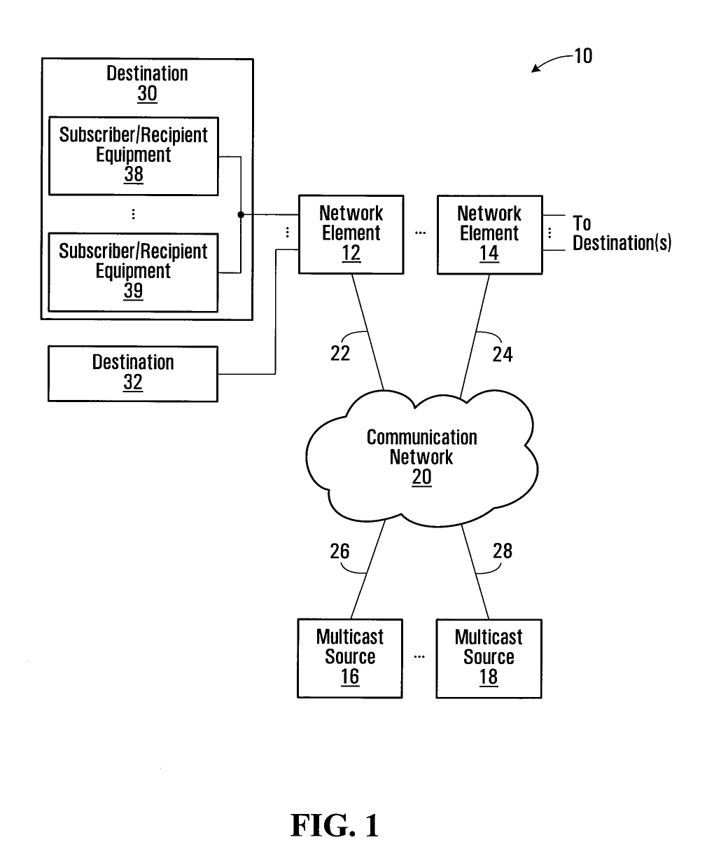

FIG. 1 is a block diagram of a communication system in which embodiments of the invention may be implemented. The communication system 10 includes network elements 12, 14 and multicast sources 16, 18 operatively coupled to a communication network 20 through respective communication links 22, 24, 26, 28. Multicast communication traffic stream destinations 30, 32 are operatively coupled to the network element 12 through respective access communication links. Other destinations may be operatively coupled to the network elements 12, 14. A destination includes one or more installations of subscriber or recipient equipment, as shown at 38, 39 for the destination 30.

A communication system may include more or fewer components, interconnected in a similar or different manner, than explicitly shown in FIG. 1. For instance, although many network elements, multicast sources, and even multiple communication networks may be interconnected to provide a multicast service, only representative examples of each type of component have been shown in FIG. 1 to avoid overly complicating the drawing. It should therefore be appreciated that the system of FIG. 1, as well as the contents of the other drawings, are intended solely for illustrative purposes, and that the present invention is in no way limited to the particular example embodiments explicitly shown in the drawings and described herein.

Each installation of subscriber/recipient equipment 38, 39 is configured for communication with the network element 12, and thus the communication network 20, over an access communication link. In one embodiment, the subscriber/recipient equipment 38, 39 includes a video receiver and a video display device, illustratively a Set-Top Box (STB) and a TV set. The video receivers may communicate with the network element 12 through Digital Subscriber Line (DSL) connections established over twisted pair loops, for instance. Other components may also be provided at a destination 30, 32. A hub device could be deployed at the destination 30 to receive communication traffic streams from the network element 12 and to distribute the received streams to each subscriber/recipient equipment installation 38, 39, for example. Such additional components have not been shown in FIG. 1 so as to avoid overly complicating the drawing.

In general, as those skilled in the art will appreciate, the subscriber/recipient equipment 38, 39 may include transceivers compatible with an access communication link, processing devices that execute communication software, operating system software, and software applications, memory devices for storing software, configuration parameters, and possibly other information, and user interfaces for receiving inputs from and/or providing outputs to users. In the case of an STB, a user interface often includes an infrared (IR) or radio frequency (RF) receiver for receiving control signals from a user-operated remote control device and manual control keys mounted on the STB. A video monitor is typically employed as an output interface for displaying received and processed video streams to a user.

Although represented in FIG. 1 as connections between the destinations 30, 32 and the network element 12, the access communication links need not necessarily be physical connections. Many different types of access communication links will be apparent to those skilled in the art. Communications between the destinations 30, 32 and the network element 12 may be provided through a wired or wireless communication medium or some combination thereof, and references herein to communication links and connections should be interpreted accordingly.

It should also be appreciated that the access communication links may include intermediate components or systems (not shown), illustratively at the destinations 30, 32, to support interoperability between different types of transceivers and different protocols implemented at the destinations and the network element 12. Thus, the access communication links may include a direct or indirect communication path between the destinations 30, 32 and the network element 12.

The network elements 12, 14, like the destinations 30, 32, are configured for communication over access communication links and include transceivers that are compatible with those links. In some embodiments, the network elements 12, 14 include the same type of transceiver as the subscriber/recipient equipment 38, 39.

Switches and routers are illustrative of the types of communication equipment represented by the network elements 12, 14. For example, where access communication links are DSL connections, the network elements 12, 14 may be DSL Access Multiplexers (DSLAMs). The network elements 12, 14 provide access to the communication network 20 for destinations such as 30, 32, and thus may be implemented within the communication network 20. However, the network elements 12, 14 have been shown separately from the communication network 20 in FIG. 1 for illustrative purposes.

For communication with the multicast sources 16, 18 through the communication network 20, the network elements 12, 14 may include further transceivers. It is also contemplated that a single physical transceiver may be used for communications on access communication links and on network communication links, with any format or protocol conversions, if necessary, being performed by a conversion unit, which might include software for execution by a processing element, in the network elements 12, 14.

The communication network 20, in addition to the network elements 12, 14, may also include intermediate network elements that route communication traffic through the communication network. Where embodiments of the invention are implemented to manage resource usage for an IPTV service, the communication network 20 would be an IP network. However, the present invention is not necessarily restricted to IP networks or to any other particular type of network.

Each multicast source 16, 18 represents a system operated by a provider of multicast communication traffic streams, illustratively IPTV video streams. A multicast source 16, 18 may generate, store, or both generate and store electronic content. Through the network elements 12, 14, the multicast sources 16, 18 provide multicast streams that may be destined for a number of destinations. As noted above, a destination may include one or more recipients.

Many different types of destination, intermediate, and network communication equipment, as well as the operation thereof, will be apparent to those skilled in the art. In a multicast scenario, the communication network 20 and the network elements 12, 14 transfer multicast communication traffic streams between the multicast sources 16, 18 and multicast destinations such as 30, 32. In one possible implementation, requests for a particular multicast stream, illustratively a specific television channel, are transmitted from the subscriber/recipient equipment 38, 39 to the network element 12. The network element 12 may then request the multicast stream from the appropriate source 16, 18 or an intermediate component in the communication network 20 from which the multicast stream is available. If the network element 12 is already receiving the multicast stream for transmission to a different destination, then no request to a multicast source may be needed since the received stream can be replicated for transmission to the requesting subscriber/recipient equipment 38, 39.

Internet Group Management Protocol (IGMP) provides one mechanism that may be used to implement multicasting. IGMP allows the distribution of multicast electronic content to be controlled on the basis of multicast groups. Respective multicast groups might be established for each of a number of IPTV channels, for example. In this context, “group” refers to a single address, which is commonly called a group address. In IPTV, IGMP is used to control the membership of STBs in those groups. That is, an STB becomes a member of a group to watch a specific channel.

A multi-stream application displays multiple streams, which would be associated with different groups in this example, on a display screen. Some program guides, for instance, integrate Picture-In-Picture (PIP) images which themselves are associated with separate multicast groups. A grid guide might be made up of multiple streams (groups) arranged together on the screen by a grid guide mosaic application.

Channel changes in an IGMP-based IPTV system might be made using control messages such as IGMP group join requests that are generated by and transmitted from subscriber/recipient equipment 38, 39 to the network element 12. In order to receive a particular IPTV channel, an IPTV subscriber effectively requests to join the corresponding multicast group. IGMP group leave requests may be used to leave groups, so as to terminate transmission of channels that are no longer being displayed. Group join and leave requests may take any of various forms. Explicit join and leave messages may be provided, for example. In other embodiments, join and/or leave actions may be implemented by an IGMP report message. These represent illustrative examples of multicast group management mechanisms. The present invention is not in any way limited to these or any other specific mechanisms.

Multicast group membership, or more generally multicast destinations, may be specific to destinations or to actual subscriber/recipient equipment. A household with multiple STBs may be considered one destination or subscriber for the purposes of multicast stream distribution. In this case, multicast streams intended for any of the multiple STBs are transmitted to a destination, and the destination or subscriber/recipient equipment itself ensures that received streams are processed and displayed by the correct installation of subscriber/recipient equipment. For example, a hub or other distribution device may be provided at the destination 30 to distribute received streams to the correct subscriber/recipient equipment 38, 39. Another possible option for a destination such as 30 would be to allow each installation of subscriber/recipient equipment 38, 39 to receive all streams destined for that destination but process only the streams that were actually requested by that subscriber/recipient equipment installation. References herein to multicast stream destinations should be interpreted accordingly, to include one or more installations of subscriber/recipient equipment and possibly other components.

Embodiments of the present invention are directed primarily to the management of resources that are used to support multicast communications. These resources may include either or both of data plane resources involved in transferring multicast communication traffic streams from multicast sources such as 16, 18 to destinations such as 30, 32 and control plane processing resources for processing associated multicast control messages. The overall management of the multicasting process, using IGMP for instance, is therefore described herein only to the extent necessary to illustrate embodiments of the invention. With the exception of multicast resource management as disclosed herein, embodiments of the invention need not necessarily significantly impact the operation of a multicasting scheme.

Resources that are available to support multicast communications, which as noted above may include control plane and/or data plane resources, may be limited by such factors as the bandwidth of the access communication links between the network elements 12, 14 and destinations such as 30, 32, and the stream handling capacity of internal components of the network elements. For example, hardware and/or software at each network element 12, 14 may provide a certain maximum data and/or control plane capacity for transmit streams that are to be concurrently transmitted to multicast destinations. Multi-stream applications such as PIP and IPTV mosaic may significantly increase demand on these limited resources. Effective techniques of managing limited multicast communication resources may therefore become more important as these and other applications are developed and deployed.

Considering the example of IPTV, suppose each destination 30, 32 includes 4 STBs as installations of subscriber/recipient equipment 38, 39, and that each STB supports a 16-channel IPTV mosaic application such as a “live” PIP program guide. Each destination may thus have a peak demand of up to 16 different channels per STB, for a total of 64 channels. Such a high number of channels per destination might not be feasible in light of multicast resource limitations at the network element 12.

The multicast resources that are available at the network element 12 could potentially be allocated equally among the destinations 30, 32 being serviced, so as to guarantee a fixed level of service to all subscribing destinations. However, this may severely impact the usage of multi-stream applications, illustratively by limiting concurrent stream capabilities to a relatively low number of streams per destination at any time. At the other extreme, no multicast resource allocations are fixed, and serviced multicast destinations must contend for resources as needed. This type of scheme tends to be prone to resource “hogging” by highly active subscribers, which can lead to service availability problems for other subscribers.

In accordance with an aspect of the invention, mosaic and other multi-stream applications are treated as add-on features that need not be guaranteed. Multicast resources are partitioned into per-destination reserved resources and a pool of remaining unreserved resources. In this way, each destination is guaranteed a base level of service, illustratively a minimum number of IPTV channels, and is also provided with an opportunity to access additional resources to support higher resource requirements. For example, an IPTV subscriber having a guarantee of 4 concurrent streams might be able to use a 16-channel mosaic application if additional resources are available from the unreserved pool. The increased resource usage by the subscriber in this example affects only the resource pool, and not the reserved resources of other subscribers.

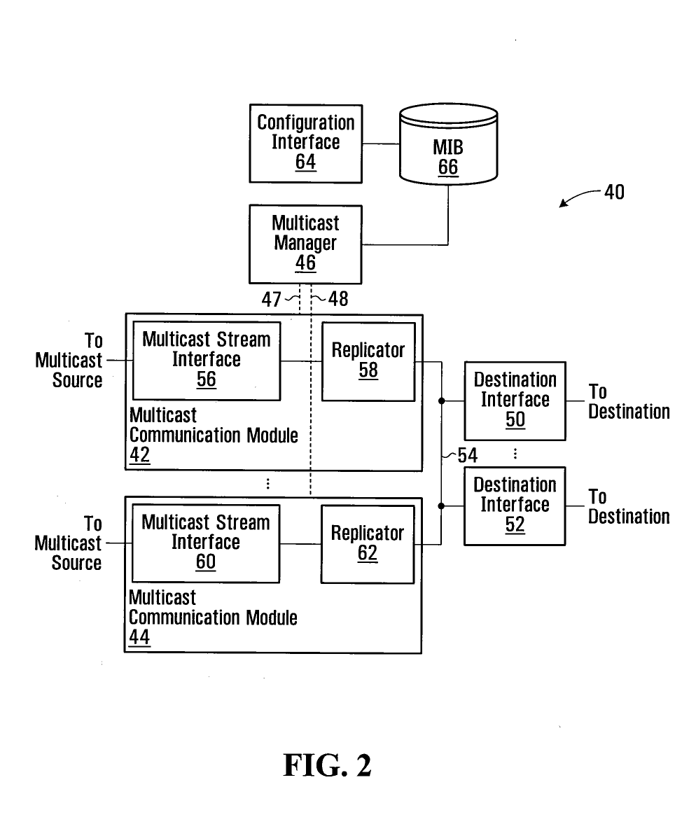

FIG. 2 is a block diagram of a multicast resource management apparatus. The apparatus 40 includes multicast communication modules 42, 44, a multicast manager 46 operatively coupled to the multicast communication modules as shown at 47, 48, destination interfaces 50, 52 operatively coupled to the multicast communication modules as shown at 54, a Management Information Base (MIB) 66 operatively coupled to the multicast manager 46, and a configuration interface 64 operatively coupled to the MIB 66.

As noted above with reference to FIG. 1, the contents of the drawings are intended solely for the purposes of illustration. For example, the device(s) or system(s) in which the apparatus 40 is implemented may include additional components that have not been explicitly shown. In general, other embodiments may include further, fewer, or different components than explicitly shown, with similar or different interconnections.

The types of connections through which the components of FIG. 2 are operatively coupled may, to at least some extent, be implementation-dependent. Electronic devices often use various types of physical connectors and wired connections. At least some of the components may be implemented on an electronic circuit card, with connections then being provided as traces. Connections might also or instead be provided through connectors, backplane conductors, and/or midplane conductors if components are implemented on different cards in card slots of a communication equipment shelf. An operative coupling might also or instead be provided through variables, registers, or commonly accessed areas of a memory, and thus include a logical coupling. This type of operative coupling is illustrated in FIG. 2 between the configuration interface 64 and the multicast manager 46, which are operatively coupled through parameters stored in the MIB 66.

Hardware, software, firmware, or combinations thereof may be used to implement the components of the apparatus 40. Processing elements such as Network Processors (NPs), microprocessors, microcontrollers, Programmable Logic Devices (PLDs), Field Programmable Gate Arrays (FPGAs), Application Specific Integrated Circuits (ASICs), and other types of “intelligent” integrated circuits may be suitable for this purpose. A single processing element may implement one or more of the illustrated components.

Each of the multicast communication modules 42, 44 includes a multicast stream interface 56, 60 and a replicator 58, 62 operatively coupled to the multicast stream interface and, through a transfer path 54, to the destination interfaces 50, 52. The multicast stream interfaces 56, 60 enable the multicast communication modules 42, 44 to at least receive multicast streams from respective multicast sources. In many implementations, the multicast stream interfaces 56, 60 will include some sort of interface to a network connection. In addition to enabling the multicast communication modules 42, 44 to receive multicast streams, these interfaces may also transfer information such as requests for multicast streams to other devices or systems, illustratively to multicast sources. The multicast stream interfaces 56, 60 may be the same or different types of interfaces, many examples of which will be apparent to those skilled in the art. Embodiments of the present invention are not restricted to any particular type of interface, protocol, or transfer mechanism for receiving multicast streams.

A replicator 58, 62 may be implemented as a multicast component that is often referred to as a root or a replication point in IP multicast systems, for example.

In terms of structure, physical components such as a number of network interfaces that either implement the multicast stream interfaces 56, 60 or are connected to the multicast stream interfaces would be provided in a communication device or equipment. These physical components, however, might not have a fixed association with a particular multicast source. Multicast communication modules 42, 44 might be provisioned or otherwise configured on an as-needed basis and according to known techniques to provide multicast roots or replication points for any of various multicast streams provided by one or more multicast sources.

The multicast manager is in one embodiment implemented in software for execution by a processor of a line card that also includes at least the destination interfaces 50, 52. Firmware and/or hardware implementations using one or more ASICs, for example, are also contemplated.

A destination interface 50, 52 enables communication with a multicast destination. A physical port, illustratively a DSL port, is one example of a destination interface. It should be appreciated, however, that the destination interfaces 50, 52 might not forward transmit streams directly to end subscribers in all embodiments. The apparatus 40 might be implemented at a multicast distribution point in a network, for example, in which case transmit streams might be sent to intermediate devices that further replicate the streams for transmission to subscriber/recipient equipment. With reference to FIG. 1, for example, the apparatus 40 could be implemented at each network element 12, 14, but may also or instead be implemented at any other point(s) between multicast destinations and the multicast sources 16, 18.

The configuration interface 64 may take any of various forms, depending at least to some extent on the device(s) or system(s) in which or in conjunction with which the apparatus 40 is implemented. Network operator or service provider personnel might access the MIB 66, and possibly other components of the apparatus 40, through a Command Line Interface (CLI) or Simple Network Management Protocol (SNMP) interface, for example. Local control or management interfaces may also or instead be provided. The structure and operation of examples of such interfaces will be known to those of skill in the art. In some embodiments, the configuration interface 64 supports multiple interface types.

The MIB 66 may be provided in one or more memory devices. Solid state memory devices are common in communication equipment, and the MIB 66 may be implemented using one or more memory devices of this type. However, other types of memory devices, including memory devices for use with movable or even removable storage media, may also or instead be used to implement the MIB 66.

Any multicast communication system will have practical constraints, which may be due to hardware or software limitations for instance. A network element or other device in which the apparatus 40 is implemented will have some maximum capacity for concurrently generating and transferring transmit signals to the destination interfaces 50, 52. A signal transfer structure 54, which has been shown as a simple connecting structure but might also include additional hardware, software, and/or firmware components, might be capable of transferring only a certain total number of transmit signals, for example. Control plane resources for processing associated multicast control messaging also have limits.

Such resource limitations have the effect of constraining the overall capacity of the multicast communication modules 42, 44 to provide transmit signals for transmission to destinations through the destination interfaces 50, 52, or more generally, the overall capacity to support multicast communications. This sort of capacity constraint may actually be caused by limitations associated with any of various multicast components. References herein to limited capacity of multicast communication modules should therefore be interpreted accordingly. Capacity may be constrained by limitations of the multicast communication modules 42, 44 themselves and/or or other components.

In accordance with an embodiment of the invention, the multicast manager 46 allows for a programmable number of multicast resources (roots) to be reserved per destination, with the remaining resources being made available, illustratively on a first-come, first-served basis, to any of the destinations. All destinations then receive a basic guaranteed level of multicast resources, such as 2 streams per STB, but can contend for the remainder of the resources. The pool of unreserved resources can make a large number of streams available to the destinations. With a low statistical concurrent usage of mosaic or other multi-stream features by multiple subscribing destinations, it may appear as though each destination has a high multi-stream availability.

These and other aspects of the invention are described in further detail below. As noted above, components of the system 40 may be implemented using hardware, software, and/or firmware. Based on the detailed descriptions of these components, a person skilled in the art will be enabled to implement resource management techniques according to embodiments of the invention in any of various ways.

In operation, the multicast communication modules 42, 44 receive respective multicast communication traffic streams and provide transmit streams for transmission toward destinations of the received multicast streams. The multicast stream interfaces 56, 60 receive the respective multicast streams, and the replicators 58, 62 replicate the received multicast streams to thereby provide the transmit streams. Each multicast stream is replicated so as to provide a separate transmit stream for each of its destinations. The replicators 58, 62 may refer to multicast group configurations stored in a memory (not shown) to determine how many times to replicate the multicast streams, and to which destination interfaces 50, 52 the resultant transmit streams are to be provided. The destination interfaces 50, 52 enable transmission of transmit streams toward respective destinations.

The multicast communication modules 42, 44 have a limited aggregate control and/or data plane capacity for supporting multicast communications. This capacity constraint may be due to limitations in the multicast communication modules 42, 44 themselves, or in other components. The aggregate capacity includes respective amounts of capacity reserved for each of the destinations associated with the destination interfaces 50, 52, as well as a remaining pool of an unreserved amount of capacity. The multicast manager 46 makes the unreserved amount of capacity available for allocation to a destination for which the respective reserved amount of capacity is insufficient.

Capacity may be reserved for the destinations substantially in accordance with currently known techniques, although in embodiments of the present invention not all available capacity is reserved. Per-destination reserved amounts may be the same for all destinations or vary between destinations, possibly based on the number and/or types of receivers at each destination. A reservation process through which capacity is reserved for each destination may also be handled by the multicast manager 46. The multicast manager 46 may, however, make unreserved capacity available for allocation to the destinations without actually being involved in the initial reservation process. For example, per-destination reserved amounts might be entered directly into the MIB 66 by using the configuration interface 64 to configure MIB parameters.

Other settings may similarly be configurable through the configuration interface 64 and the MIB 66. A service provider might wish to restrict how much of the total capacity of a network element is subject to this type of “base plus pool” management technique, for example. Particular multicast communication modules 42, 44, destination interfaces 50, 52, and/or subscribers could be designated as participating or not participating. Aggregate capacity could also or instead be set to a level that is at or below the actual maximum capacity. A lower setting could be configured so as to place a fixed limit on resource consumption for instance. Pool size is another parameter that might be set in some embodiments. Based on aggregate capacity and a minimum pool size, service provider personnel or a component such as the multicast manager 46 might determine and set per-destination reserved capacity amounts to provide the desired size of an unreserved pool.

Amounts of capacity could be specified in terms of numbers of transmit signals or channels in some embodiments. Each destination can thereby be guaranteed to have access to at least a minimum number of roots or groups, and thus channels, at any time. A reservation of a number of roots might reserve both data plane resources and associated control plane resources for that number of roots. Other delineators of amounts of capacity are also possible.

In some embodiments, the multicast manager 46 makes the unreserved capacity available by controlling allocation of additional amounts of capacity from the unreserved pool to destinations for which the respective currently reserved amounts of capacity are insufficient. Reserved capacity might be insufficient where a subscriber wishes to run a multi-stream application that requires more than the guaranteed reserved number of streams for instance. As described in further detail below, the multicast manager 46 determines whether required additional capacity is available from the unreserved pool, and if so, allocates the additional capacity to the requesting destination.

Additional capacity allocation may be request-driven. In this case, the multicast manager 46 receives requests from destinations for allocation of additional amounts of capacity.

Any of several mechanisms may be provided to implement this feature. The multicast manager 46 could be operatively coupled to the destination interfaces 50, 52 to receive requests to join IGMP groups or other forms of capacity requests from each destination. In another embodiment, the multicast manager 46 cooperates with the replicators 58, 62 or another component of the multicast communication modules 42, 44 to receive such requests. Since the multicast communication modules 42, 44 are involved in actually providing multicast signals to the destinations, these modules might also be involved in stream or capacity request processing. In this type of scenario, the multicast communication modules 42, 44 might receive requests from destinations, but defer to the multicast manager 46 to determine whether the requests should be granted. The actual received requests, or some other form of request or command, could be sent from the multicast communication modules 42, 44 to the multicast manager 46.

When an additional amount of capacity is requested by a destination, the multicast manager 46 determines whether the requested additional amount of capacity is available from the unreserved pool, and if so, allocates the requested additional amount of capacity from the pool to the requesting destination. Allocated capacity is temporarily unavailable from the pool. The entire amount of requested capacity need not always be available in the pool in order for a request to be granted. A destination might be under its reserved capacity when a request is received, for example. In this case, the multicast manager 46 determines the actual additional capacity, above reserved capacity, that would be required to grant the request, and the allocation decision is based on whether the required additional capacity is available from the pool.

Allocation may be accomplished in substantially the same manner as base reservations. However, two different terms for reserved and allocated additional amounts of capacity have been used herein to indicate the different nature of allocations and reservations. Base reservations may be maintained for a destination regardless of actual usage, whereas additional allocations might be released, entirely or in part, and returned to the pool when a reduced amount of capacity is sufficient for a destination. The multicast manager 46 might determine that a reduced amount of capacity is sufficient for a destination when it receives a request from the destination to leave an IGMP group, for instance. Previously allocated but released capacity again becomes available for subsequent re-allocation to a destination. Released capacity might later be allocated to a different destination or possibly to the same destination if that destination again requires additional capacity.

In the event that requested additional capacity is not available from the pool, the multicast manager 46 might deny the request. Where the multicast manager 46 is in the request path, it might block forwarding of the request to a multicast communication module 42, 44, for example, to thereby prevent the destination from becoming a member of the multicast group. The multicast manager 46 might instead inform a multicast communication module 42, 44 by which a request has been received that the request should not be granted, or instruct the multicast communication module not to allow the destination to become a member of its multicast group.

Some embodiments may provide for allocation of a portion of requested additional capacity where the pool includes some available capacity, but not sufficient capacity to allocate all of the requested additional capacity. That is, if sufficient unreserved resources are not available, a reduced additional amount of capacity might be allocated to a destination. The multicast manager 46 might thus allow a destination to receive some additional streams, but perhaps not all requested streams.

One contention mechanism that may be applied to controlling allocation of additional unreserved capacity from the pool is a first-come, first-served mechanism. Unreserved capacity is allocated to requesters in order of request receipt. However, other conditions may also or instead be taken into account during the allocation control process. For example, maximum total capacity limits could be configured as a global parameter or on a per-destination basis in the MIB 66. Once a destination has reserved and allocated its maximum total capacity, further requests for additional capacity could be denied. This would prevent highly active users from dominating the pool.

A contention mechanism might also or instead handle simultaneous requests for additional capacity. The multicast manager 46 might determine whether a total of additional amounts of capacity requested in the received requests is available from the pool, and allocate the requested amounts if sufficient capacity is available from the pool. If not, the contention mechanism could be applied to select one or more of the received requests for which requested additional amounts of capacity are to be allocated from the pool. The multicast manager 46 might select requests based on the requesting destinations, the amounts of requested capacity, the type of stream or group to which the request relates, whether granting a request would exceed a total maximum capacity for any of the destinations, and/or other criteria.

Once additional capacity has been allocated to a destination, the multicast communication modules 42, 44 can begin sending additional transmit signals to the destination. This involves adding the destination as a member of a multicast group in some embodiments. The multicast manager 46 might interact with the replicators 58, 62 or another component of the multicast communication modules 42, 44 to add the destination as a member of the appropriate group(s). Some implementations may support a more direct configuration of groups or multicasting by the multicast manager 46, such that the multicast manager itself adds destinations as members of groups as requests for additional capacity are granted.

A request for additional capacity may be denied entirely or in part where only a portion of the requested additional capacity is available from the pool, as described above. At subscriber/recipient equipment, a partially granted request might affect operation of a multi-stream function such as PIP or mosaic. Although a multi-stream application may execute at the subscriber/recipient equipment, a notification icon could be displayed instead of a particular stream as part of a mosaic. This provides an indication to a user that not all requested streams could be transmitted.

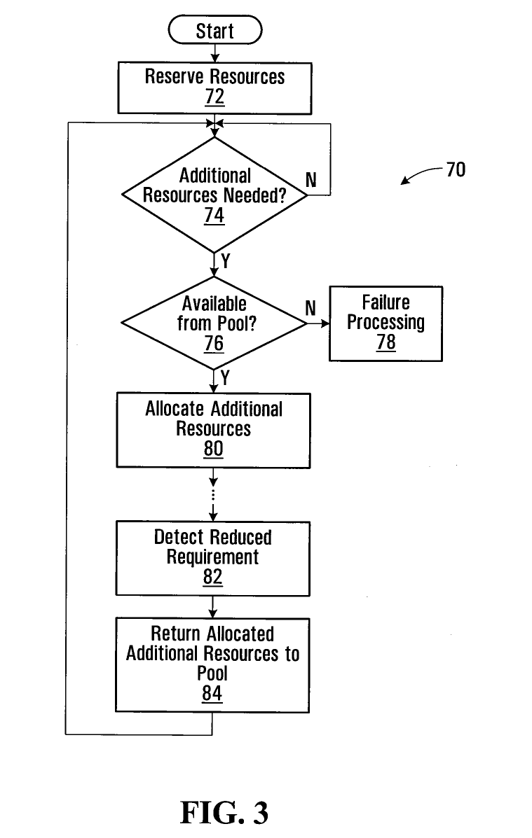

FIG. 3 is a flow diagram of a multicast resource management method. The method 70 includes an operation 72 of reserving resources. In one embodiment, the resources are in the form of a limited aggregate capacity to support multicast communications with multicast destinations, and respective amounts of that capacity are reserved at 72 for each of the multicast destinations. Use of the respective reserved amounts of capacity is enabled, such as by allowing destinations to join up to a reserved number of multicast groups.

A pool of unreserved capacity that remains following per-destination reservation at 72 is made available for allocation to one or more destinations for which the respective reserved amounts of capacity are insufficient. If a destination requires additional resources, which in this example is capacity, as determined at 74 upon receipt of a request from a destination for instance, a determination is then made at 76 as to whether the required amount of additional capacity is available from the pool. If not, the method 70 then reverts to failure processing at 78, which may include blocking the request or advising a multicast group controller that the requesting destination should not become a member of a multicast group.

Additional resources are allocated at 80 if available from the pool. At some later time, a reduced requirement for resources is detected at 82. A request to leave an IGMP group might have been received, for example. Allocated additional resources, or at least a portion thereof, are released and returned to the pool at 84. The released resources are then available in the pool for re-allocation.

It should be appreciated that the method 70 is illustrative of one embodiment of the invention. Other embodiments may involve fewer, additional, or different operations, and/or performing operations in a different order than shown. For example, the operation at 74 may be an ongoing monitoring operation instead of a sequential operation that ends when a request is received, such that multiple requests may be received and processed substantially simultaneously. In terms of ordering, allocation at 80 and release at 82 may be independently performed. Reduced resource requirements could be detected in a similar manner as additional resource requirements, such as by monitoring for requests to leave IGMP groups, for example. In addition, the operations shown in FIG. 3 may be performed in any of various ways, some of which have been described above. Configuration, partial allocation, contention, and/or other operations may also be performed in conjunction with the method 70, but have not been explicitly shown in FIG. 3 to avoid overly complicating the drawing.

Further variations of the method 70 may be or become apparent to those skilled in the art, from the foregoing description of FIGS. 1 and 2 for instance.

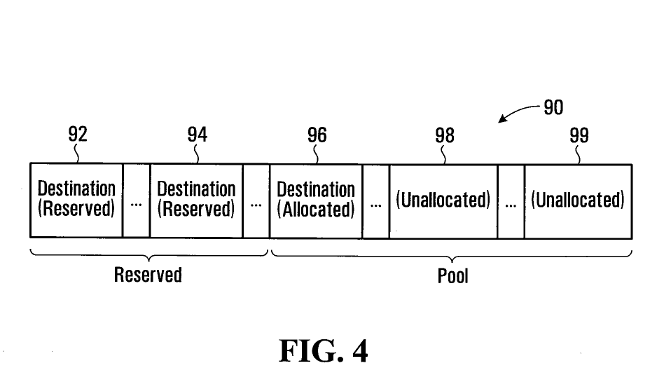

FIG. 4 is a block diagram of an example data structure that may be used to track reserved resources and a pool of unreserved resources. The data structure 90 might be used in a machine-readable medium such as a memory device in which the MIB 66 (FIG. 2) is provided. As shown, the example data structure 90 includes data fields 92, 94 that are indicative of reserved resources, and data fields 96, 98, 99 that are indicative of unreserved resources.

The reserved fields 92, 94 may be storage locations that are associated with resources. In the example shown, the reserved fields 92, 94 include identifiers of the destinations for which the resources have been reserved. A separate parameter or flag associated with a reserved field 92, 94 could then be used to indicate whether each reserved resource is actually in use. Reserved resource data fields could instead be populated with a destination identifier only when in use. In this case, the destination identifiers indicate the usage states of the reserved resources. Indications of usage states might be accessed in order to determine whether each destination, for which additional capacity is being requested, is actually using its base reserved capacity.

Allocation states of the pool resources might be similarly indicated by a flag or an identifier. A destination identifier in a pool resource data field 96, 98, 99 could be used to provide an indication of allocation state and thus availability of the resource. In the example shown, the resource associated with the data field 96 has been allocated, whereas the resources associated with the data fields 98, 99 are unallocated and thus available.

Indications of reserved and unreserved resources could instead be provided in other forms, such as pointers that associate destinations with some sort of records or objects representing resources that have been reserved for or allocated to those destinations. Thus, data structures according to other embodiments may vary from the specific example structure shown in FIG. 4. In general, multicast resource management techniques as disclosed herein could be supported by any of various data structures that include reserved and unreserved resource data fields. The reserved resource data fields are indicative of multicast communication resources that have been respectively reserved, from limited resources for supporting multicast communications with multicast destinations, for each of the destinations, whereas the unreserved resource data fields are indicative of remaining unreserved resources of the limited resources and availability of the unreserved resources. These resource data fields enable determinations to be made as to whether resources reserved for a destination are insufficient, and whether additional resources are available from the unreserved resources for allocation to the destination where the resources reserved for the destination are insufficient.

Embodiments of the invention as disclosed herein can be used to provide a configurable number of guaranteed multicast roots per port at a limited multicast communication resource point, and to provide the remainder of multicast roots via a pool. After a port consumes its guaranteed root resources, it is able to contend fairly with the other ports, at that limited resource point, for any available resources in the pool.

In this way, a limited number of resources per system or card can appear to end users as a large number of multicast streams. The scalability of existing systems can be greatly increased, potentially eliminating or at least delaying the need for hardware replacement.

What has been described is merely illustrative of the application of principles of embodiments of the invention. Other arrangements and methods can be implemented by those skilled in the art without departing from the scope of the present invention.

For example, the divisions of function shown in FIG. 2 are intended solely for illustrative purposes. Embodiments of the invention may be implemented using further, fewer, or different components than shown.

Other functions than those specifically described above might also be supported in some embodiments. A reclaiming mechanism could be provided, for instance, to reclaim allocated resources when a request for additional resources cannot otherwise be granted. A reclaim decision could be based on the current usage level of a requesting destination, a hierarchy or priority order of destinations or stream types, and/or other criteria. A request by a destination for one additional stream above its reserved number of streams, for instance, could potentially be granted even when all pool resources are allocated, by reclaiming an allocated stream from a destination that is currently further above its reserved number of streams.

Stream type variations are also contemplated. Where stream types are identified, there may be certain reservations depending upon stream type with any overage coming from the pool. Multiple levels of a base plus pool management scheme could be implemented, for example. This might involve classifying the types of multicast streams and offering different amounts of base and/or pool resources based on stream type. For instance, full resolution TV images and PIPs might be classified as different stream types. For each household, 4 full resolution streams (FRSs) could be reserved, to allow every household to always watch up to 4 TV shows. A reservation could also be made for 8 PIP streams per household, illustratively allowing at least 1 PIP per STB or 1 mosaic per household, with any additional capacity then coming from the pool. Such a type-based resource management scheme provides further granularity on resource control.

In addition, although described primarily in the context of methods and systems, other implementations of the invention are also contemplated, as instructions stored on a machine-readable medium, for example.

We claim:

1. An apparatus comprising:
a plurality of multicast communication modules operable to receive respective multicast communication traffic streams and to provide transmit streams for transmission toward destinations of the received multicast streams, the plurality of multicast communication modules having a limited aggregate capacity to support multicast communications with the plurality of destinations, the aggregate capacity comprising respective amounts of capacity reserved for each of the destinations and a remaining unreserved amount of capacity; and
a multicast manager operatively coupled to the multicast communication modules and operable to make the unreserved amount of capacity available for allocation to a destination for which the respective reserved amount of capacity is insufficient.

2. The apparatus of claim 1, wherein the multicast manager is further operable to reserve the respective amounts of capacity for each of the destinations.

3. The apparatus of claim 1, wherein the multicast manager is operable to make the unreserved capacity available by controlling allocation of an additional amount of capacity from the unreserved amount of capacity to a destination for which the respective reserved amount of capacity is insufficient.

4. The apparatus of claim 1, wherein each multicast communication module of the plurality of multicast communication modules comprises:
a multicast stream interface operable to receive a respective multicast stream; and
a replicator operatively coupled to the multicast stream interface and operable to replicate the received multicast stream to thereby provide a respective transmit stream for transmission toward each destination of the received multicast stream.

5. The apparatus of claim 1, further comprising:
a plurality of destination interfaces operatively coupled to the multicast communication modules, each destination interface being operable to enable transmission of transmit streams to one of the destinations.

6. The apparatus of claim 1, further comprising:
a configuration interface operatively coupled to the multicast manager and operable to enable configuration of at least one of: the aggregate capacity, the respective reserved amounts of capacity, and the unreserved amount of capacity.

7. The apparatus of claim 3, wherein the multicast manager is further operable to receive from any of the destinations a request for allocation of an additional amount of capacity, and to control allocation of an additional amount of capacity from the unreserved amount of capacity responsive to a received request by determining whether a requested additional amount of capacity is available from the unreserved amount of capacity, and allocating the requested additional amount of capacity from the unreserved amount of capacity where the requested additional amount of capacity is available from the unreserved amount of capacity.

8. The apparatus of claim 7, wherein the multicast manager is further operable to allocate a reduced additional amount of capacity from the unreserved amount of capacity where the requested additional amount of capacity is not available from the unreserved amount of capacity.

9. The apparatus of claim 7, wherein the multicast manager is further operable, where a plurality of requests are received, to control allocation of additional amounts of capacity by determining whether a total of additional amounts of capacity requested in the plurality of requests is available from the unreserved amount of capacity, and selecting, in accordance with a contention mechanism, one or more of the plurality of received requests for which requested additional amounts of capacity are to be allocated from the unreserved amount of capacity where the total of additional amounts of capacity requested in the plurality of requests is not available from the unreserved amount of capacity.

10. The apparatus of claim 7, wherein the multicast manager is further operable to, where a reduced amount of capacity is sufficient for a destination, release at least a portion of an additional amount of capacity that has been allocated to the destination, released capacity being available for re-allocation to a destination.

11. The apparatus of claim 1, wherein the multicast communication traffic streams are video streams associated with an Internet Protocol Television (IPTV) service.

12. An electronic circuit card for use in communication equipment, the electronic circuit card comprising the apparatus of claim 1.

13. Communication equipment comprising:
a plurality of slots for receiving electronic circuit cards; and
an electronic circuit card as defined in claim 12 installed in at least one slot of the plurality of slots.

14. A method of using a limited aggregate capacity to support multicast communications with a plurality of multicast destinations, the aggregate capacity comprising respective amounts of capacity reserved for each of the destinations and a remaining unreserved amount of capacity, the method comprising:
enabling the reserved amounts of capacity to be used for communications with the respective destinations; and
making the unreserved amount of capacity available for allocation to a destination for which the respective reserved amount of capacity is insufficient.

15. The method of claim 14, further comprising:
reserving the respective amounts of capacity for each of the destinations.

16. The method of claim 14, wherein making the unreserved amount of capacity available comprises controlling allocation of an additional amount of capacity from the unreserved amount of capacity to a destination for which the respective reserved amount of capacity is insufficient.

17. The method of claim 14, further comprising:
receiving from a user a configuration input for configuring at least one of: the aggregate capacity, the respective reserved amounts of capacity, and the unreserved amount of capacity.

18. The method of claim 16, further comprising:
receiving from any of the destinations a request for allocation of an additional amount of capacity,
wherein controlling comprises:
determining whether a requested additional amount of capacity is available from the unreserved amount of capacity; and
allocating the requested additional amount of capacity from the unreserved amount of capacity where the requested additional amount of capacity is available from the unreserved amount of capacity.

19. The method of claim 18, wherein controlling further comprises:
allocating a reduced additional amount of capacity from the unreserved amount of capacity where the requested additional amount of capacity is not available from the unreserved amount of capacity.

20. The method of claim 18, wherein controlling further comprises, where a plurality of requests are received:
determining whether a total of additional amounts of capacity requested in the plurality of requests is available from the unreserved amount of capacity; and
selecting, in accordance with a contention mechanism, one or more of the plurality of requests for which requested additional amounts of capacity are to be allocated from the unreserved amount of capacity where the total of additional amounts of capacity requested in the plurality of requests is not available from the unreserved amount of capacity.

21. The method of claim 18, further comprising:
determining whether a reduced amount of capacity is sufficient for a destination to which an additional amount of capacity has been allocated from the unreserved amount of capacity; and
releasing at least a portion of the additional amount of capacity where a reduced amount of capacity is sufficient for the destination, released capacity being available for re-allocation to a destination.

22. The method of claim 14, wherein the multicast communication traffic streams are video streams associated with an Internet Protocol Television (IPTV) service.

23. A machine-readable medium storing instructions which when executed perform the method of claim 14.

24. A machine-readable medium storing a data structure, the data structure comprising:
reserved resource data fields indicative of multicast communication resources that have been respectively reserved, from limited resources for supporting multicast communications with a plurality of multicast destinations, for each of the destinations; and
unreserved resource data fields indicative of remaining unreserved resources of the limited resources and availability of the unreserved resources,
the reserved resource data fields and the unreserved resource data fields enabling determinations to be made as to whether resources reserved for a destination are insufficient, and whether additional resources are available from the unreserved resources for allocation to the destination where the resources reserved for the destination are insufficient.
